(19) United States
(12) Patent Application Publication
(10) Pub. No.: US 2017/0115447 A1
(43) Pub. Date: Apr. 27, 2017

(54) PRISM SHEET AND PLANAR ILLUMINATION DEVICE

(71) Applicant: MINEBEA CO., LTD., Kitasaku-gun (JP)

(72) Inventor: Masao MIYAMOTO, Fukuroi (JP)

(73) Assignee: MINEBEA CO., LTD., Kitasaku-gun (JP)

(21) Appl. No.: 15/333,450

(22) Filed: Oct. 25, 2016

(30) Foreign Application Priority Data
Oct. 27, 2015 (JP) 2015-210693

(51) Int. Cl. F21V 8/00

(52) U.S. Cl. CPC G02B 6/0053; G02B 6/0031; G02B 6/0056; G02B 6/0051

(57) ABSTRACT

A prism sheet according to an embodiment includes a transparent plate portion and a plurality of prism portions provided on a light incidence side of the transparent plats portion and configured to deflect light. Each of the plurality of prism portions has a shape obtained by combining a first prism with a second prism. The first prism has a first triangular prismatic shape. The second prism has a second triangular prismatic shape. Each of the plurality of prism portion has a shape in which the prism width of the first prism is larger than the prism width of the second prism, in which the height of the first prism is smaller than the height of the second prism, and in which an edge line of the first prism substantially overlaps an edge line of the second prism. The edge lines of the prism portions are parallel to one another.

### CROSS-REFERENCE TO RELATED APPLICATION(S)

The present application claims priority to and incorporates by reference the entire contents or Japanese Patent Application No. 2015-210693 fixed in Japan on Oct. 27, 2015.

### BACKGROUND OF THE INVENTION

1. Field of the Invention

The present invention relates to a prism sheet and a planar illumination device, and is, in particular, preferably applied to a planar illumination device used, for an in-vehicle backlight.

2. Description of the Related Art

Development has been heretofore made for planar illumination devices in order to improve viewability of a screen from two directions inclined from the normal direction thereof, specifically, for example, from directions corresponding to the driver's seat and the front passenger's seat in a vehicle. For example, Japanese Patent Application Laid-open Publication No. 2007-294465 discloses an illumination device in which, in order to obtain peaks in luminance at two positions on the right and left sides with respect to the normal direction of a display screen, a light diffusion plate, a first optical sheet made of a downward-facing prism sheet, a second optical sheet made of an upward-facing prism sheet, and a polarizing separation plats are sequentially arranged on a light emitting surface side of a light guide plate.

When a planar illumination device is employed in an in-vehicle electronic device or the like, a display screen thereof may fee required to be viewed not only from the two directions corresponding to the driver's seat and the front passenger's seat, but also, for example, from a passenger on the rear seat. To meet this requirement, the viewable range of the electronic device including the planar illumination device needs to be wide toward both the right and left sides with respect to the normal direction of the surface of the display screen.

### SUMMARY OF THE INVENTION

It is an object of the present invention to at least partially solve the problems in the conventional technology.

A prism sheet according an embodiment includes a transparent plate portion having a flat plate-like shape, and configured to transmit at least part of visible light; and a plurality of prism portions provided on a main surface of the transparent plate portion, and deflects at least part of the visible light. Each of the plurality of prism portions has a shape obtained by combining at least a first prism and a second prism. The first prism has a first triangular prismatic shape having a sectional shape of an obtuse triangle when cut orthogonally to a longitudinal direction of the first prism. A side surface side of the first prism corresponding to a base of the obtuse triangle in the first triangular prismatic shape is disposed on the transparent plate portion side of the first prism. The second prism has a second triangular prismatic shape having a sectional shape of a triangle having a vertex angle of 90 degrees or smaller when cut orthogonally to a longitudinal direction of the second prism. A side surface side of the second prism corresponding to a base of the triangle in the second triangular prismatic shape is disposed on the transparent plate portion side of the second prism. Each of the plurality of prism portion has a shape in which a prism width of the base of the obtuse triangle in the first prism is larger than a prism width of the base of the triangle in the second prism, in which a height of the obtuse triangle in the first prism is smaller than a height of the triangle in the second prism, and in which an edge line of the first prism substantially overlaps an edge line of the second prism when looked down from a normal direction of the main surface. Edge lines of the second prisms are substantially parallel to one another in the plurality of prism portions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a vertical sectional view illustrating the overall configuration of a planar illumination device according to an embodiment of the present invention;

FIG. 2 is a perspective view illustrating an essential part of a prism sheet according to the embodiment of the present invention;

FIG. 3 illustrates an essential part of a sectional view taken along line III-III in FIG. 2;

FIG. 4 is a schematic diagram for explaining various parameters in the prism sheet according to the embodiment of the present invention;

FIG. 5 is a graph illustrating relative luminance depending on the angle from the normal direction (0 degrees) of a planar illumination device that includes the prism sheet according to the embodiment of the present invention and of a planar illumination device that does not include the prism sheet;

FIG. 6 is a graph illustrating light distributions of the planar illumination device according to the embodiment of the present invention, a planar illumination device with a different arranging order of the prism sheet, and a planar illumination device provided with no prism sheet;

FIG. 7 is a graph illustrating light distributions of the planar illumination device according to the embodiment of the present invention in the cases where the arrangement pitch of prism portions of the prism sheet is varied;

FIG. 8 is a graph illustrating relative light intensities depending on the angle from the normal direction (0 degrees) of planar illumination devices in the case where the vertex angle of each first prism in the prism sheet according to the embodiment of the present invention is fixed to 160 degrees and the vertex angle of each second prism is varied from 40 degrees to 90 degrees, and in the case of a conventional technique;

FIG. 9 is a graph illustrating the relative light intensities depending on the angle from the normal direction (0 degrees) of the planar illumination device in the case where the vertex angle of the first prism in the prism sheet according to the embodiment of the present invention is fixed to 140 degrees and the vertex angle of the second prism is varied from 40 degrees to 80 degrees, and in the case of the conventional technique;

FIG. 10 is a graph illustrating the relative light intensities depending on the angle from the normal direction (0 degrees) of the planar illumination device in the case where the vertex angle of the first prism in the prism sheet according to the embodiment of the present invention is fixed to 120 degrees and the vertex angle of the second prism is varied from 40 degrees to 60 degrees, and in the case of the conventional technique; and

FIG. 11 is a graph illustrating relative light intensities in the cases where the light distribution angle of light incident on the prism sheet according to the embodiment of the present invention is varied from 10 degrees to 60 degrees.

### DETAILED DESCRIPTION OF THE PREFERRED EMBODIMENT

The following describes an embodiment of the present invention with reference to the drawings. In all the drawings of the embodiment referenced below, the same reference numerals are assigned to the same or corresponding parts. The embodiment to be described below is not intended to limit the present invention.

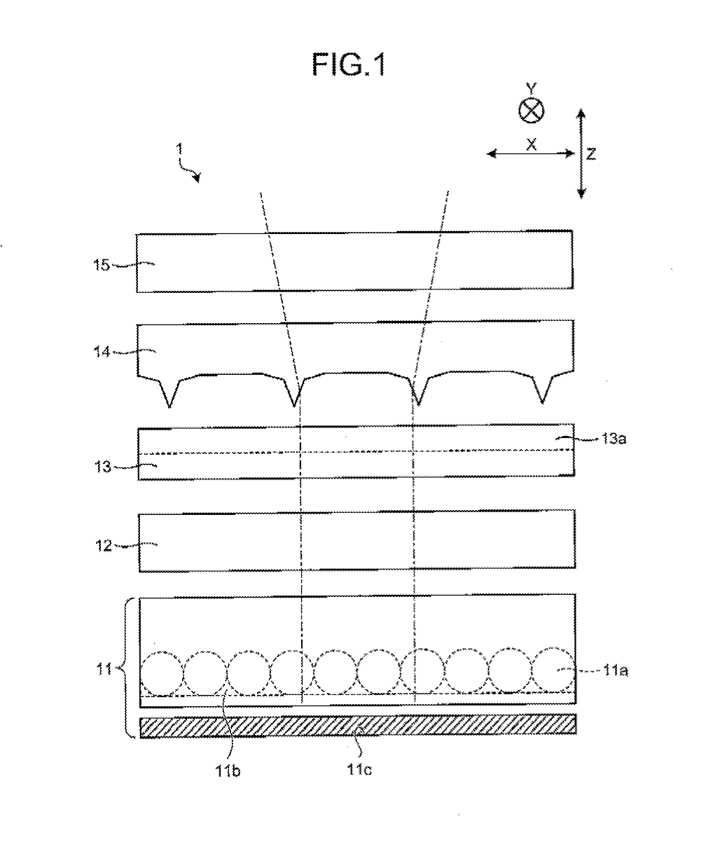

FIG. 1 is a vertical sectional view illustrating a planar illumination device according to the embodiment of the present invention. This planar illumination device 1 according to this embodiment includes a planar light source 11, a light diffusion plate 12, an optical sheet 13, a prism sheet 14 according to the embodiment of the present invention, and a polarizing separation plate 15.

The planar light source 11 has a planar illumination area. The light diffusion plate 12 is disposed on a light emitting side of the planar light source 11. The light diffusion plate 12 is provided for uniformizing the luminance of illumination light emitted from the planar light source 11, and can employ various conventionally known configuration. The optical sheet 13 is made of, for example, a brightness enhancement film (BEF), and is disposed on the light emitting side of the light diffusion plate 12. The prism sheet 14 according to this embodiment is disposed on the light emitting side of the optical sheet 13. The prism sheet 14 will be described later in detail. The polarizing separation plate 15, such as a reflective polarizing plate made of, for example, a dual brightness enhancement film (DBEF), or an absorptive polarizing plate, is disposed on the light emitting side of the prism sheet 14. The light diffusion plate 12 and the polarizing separation plate 15 can be omitted.

The planar light source 11 includes a light source 11a, a light guide plate 11b, and a reflecting plate 11c, and emits light, such as visible light, in a planar form. The light source 11a is composed of point light sources, such as a plurality of light-emitting diodes (LEDs), or linear light sources, such as cold-cathode tubes. If the light source 11a is composed of the light-emitting diodes (LEDs) as illustrated in FIG. 1, the arrangement direction of the LEDs is parallel to the direction of extension of edge lines of the optical sheet 13 made of, for example, a BEF, and orthogonal to edge lines of prisms included in the prism sheet 14 (to be described later). The light guide plate 11b is configured to introduce the light emitted from the light source 11a from a light incidence surface serving as an end surface, and to output the light from a light emitting surface (upper surface in FIG. 1) while interiorly propagating the light in a direction orthogonal to the horizontal direction (X-direction in FIG. 1). The reflecting plate 11c is disposed on the bottom surface side (lower surface side in FIG. 1) of the light guide plats 11b. In the following description, for the sake of convenience, a direction orthogonal to the X-direction and orthogonal to the plane of the drawing of FIG. 1 will be referred to as the Y-direction, and a direction orthogonal to the X-direction and the Y-direction will be referred to as the Z-direction.

The optical sheet 13 is made of a translucent resin material, such as a polyester resin, a polyethylene resin, an acrylic resin, a polycarbonate resin, or optical glass. From the viewpoint of the deflecting effect, optical transmittals, resistance to impact, resistance to damage, and durability of a light deflection surface, the refractive index of the material of the optical sheet 13 is preferably in the range from 1.3 to 1.7, and more preferably in the range from 1.4 to 1.6. The planar light source 11 side, that is, the light incidence side of the optical sheet 13 is a flat surface, and the light emitting side of the optical sheet 13 is provided with a light deflection surface 13a that is configured by arranging a plurality of pairs of mutually inclined prism surfaces.

### Prism Sheet

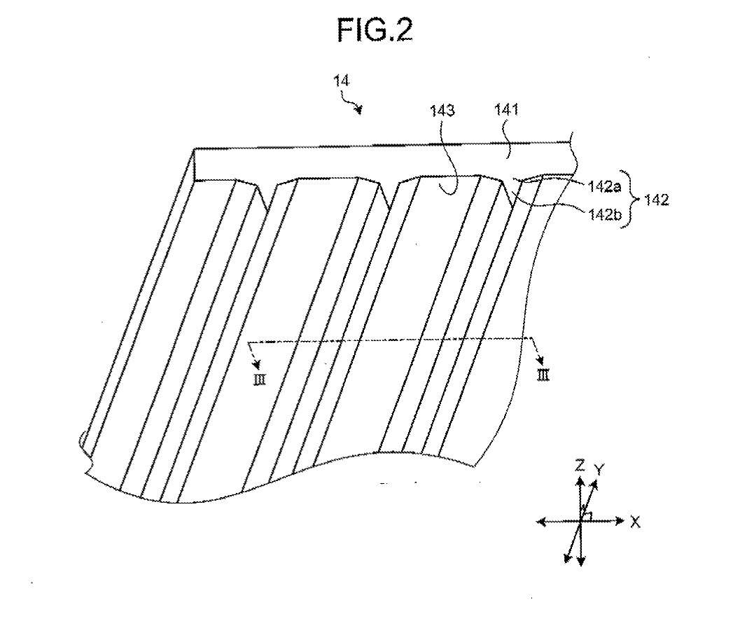

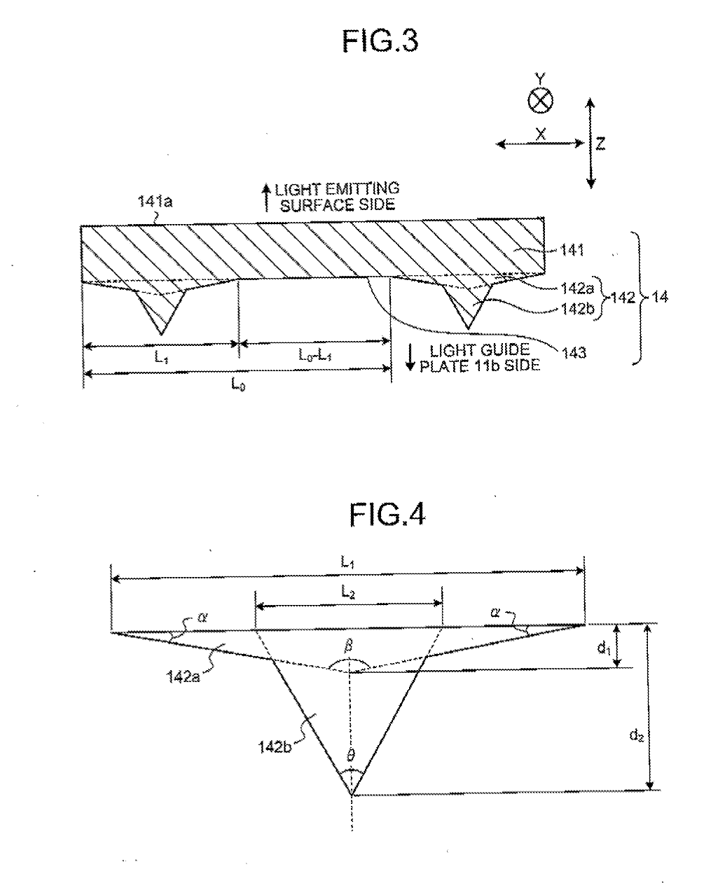

The following describes the prism sheet 14 according to the embodiment of the present invention. Specifically, an optical sheet illustrated in FIGS. 2, 3, and 4 is used as the prism sheet 14 according to this embodiment. FIG. 2 is a perspective view looking down the prism sheet 14 according to this embodiment from an incoming direction of light. FIG. 3 is a sectional view taken along line III-III in FIG. 2. FIG. 4 is a schematic diagram for explaining various parameters for a deflection portion included in the prism sheet 14 according to this embodiment.

As illustrated in FIGS. 2, 3, and 4, the prism sheet 14 according to this embodiment is composed of a flat plate-like portion 141, prism portions 142, and flat surface portions 143. The prison portions 142 are provided on a main surface on the light guide plate 11b side of the flat plate-like portion 141 that serves as a transparent plate portion transmitting at least part of visible light. The flat surface portions 143 are provided between adjacent ones of the prism portions 142. The prism portions 142 and the flat surface portions 143 on the light guide plate 11b side of the prism sheet 14 form a light deflection surface. A light emitting surface side of the flat plate-like portion 141 serving as a back surface thereof forms a flat surface 141a.

As illustrated on FIG. 3, the prism portions 142 having a prism width L₁ are arranged in parallel with one another at an arrangement pitch L₀ long the X-direction orthogonal to the longitudinal direction of the prism portions 142. The prism width L₁ the prism portions 142 is the prism width L₁ of a first prism 142a. From a structural point of view, the ratio (L₀/L₁) of the arrangement pitch L₀ to the prism width L₁ of the prism portions 142 is equal to or larger than 1, and is preferably from 1 to 2, both inclusive (1≦L₀/L₁≦2). In this embodiment, the prism width L₁ is set to, for example, 50 μm, the arrangement pitch L₀ is set to, for example, 100 μm, and the ratio (L₀/L₁) of the arrangement pitch L₀ to the prism width L₁ is set to, for example, 2.

Each of the prism portions 142 on the light deflection surface has a shape formed by stacking a triangular prism having a triangular section on an upper surface corresponding to the upper base of a quadrangular prism having a trapezoidal section orthogonal to the longitudinal direction thereof so that a side surface of the triangular section can adjoin the upper surface. In other words, the prism portion 142 has a shape obtained by combining the first prism 142a of a hypothetical triangular prismatic shape with a second prism 142b of a hypothetical triangular prismatic shape. With this configuration, the prism portion 142 has the function of deflecting at least visible light. An edge line of the second prism 142b serves as an edge line of the prism portion 142, and a plurality of such second prisms 142b are provided so that the edge lines thereof are substantially parallel to one another. Hereinafter, this specification will be described using the first prism 142a and the second prism 142b.

Each of the first prisms 142a and the second prisms 142b has a triangular shape in the section (XZ section) orthogonal to the longitudinal direction (Y-direction) of the triangular prismatic shape, and in this embodiment, has, for example, a substantially isosceles triangular shape. The first prism 142a has an obtuse triangular shape as the XZ sectional shape, and specifically, has a triangular prismatic shape (first triangular prismatic shape) that is, for example, an obtuse isosceles triangular shape as the XZ sectional shape. The second prism 142b has a right triangular shape or an acute triangular shape as the XZ sectional shape, and specifically, has a triangular prismatic shape (second triangular prismatic shape) that is, for example, an isosceles triangular shape having the vertex angle of 90 degrees or smaller as the XZ sectional shape.

Regarding the first prism 142a, the opposite side of the vertex angle of the isosceles triangle (hereinafter, called the vertex angle of the first prism 142a) forming an angle β that is an obtuse angle, that is, the bottom surface that is a side surface of the first prism 142a corresponding to the bass of the isosceles triangle having a length L₁ is located on the flat plate-like portion 141 side. The base angle of this isosceles triangle is an angle α (2α+β=180 degrees). The angle β is typically larger than 90 degrees and equal to or smaller than 170 degrees (90°<β≦170°), is preferably from 120 degrees to 160 degrees, both inclusive (120°≦β≦160°), is more preferably from 140 degrees to 160 degrees, both inclusive (140°≦β≦160°), and in this embodiment, for example, 160 degrees.

Regarding the second prism 142b, the opposite side of the vertex angle of the isosceles triangle (hereinafter, called the vertex angle of the second prism 142b) forming an angle θ equal to or smaller than the right angle, that is, the bottom surface that is a side surface of the second prism 142b corresponding to the base of the isosceles triangle having a length L₂ is located on the flat plate-like portion 141 side. The angle θ is typically from 40 degrees to 90 degrees, both inclusive (40°≦θ≦90°), is preferably from 40 degrees to 80 degrees, both inclusive (40°≦θ≦80°), is more preferably from 40 degrees to 60 degrees, both inclusive (40°≦θ≦60°), and in this embodiment, for example, 58 degrees.

As illustrated in FIG. 4, in this embodiment, the first prism 142a and the second prism 142b provided so as to overlap the first prism 142a are arranged so that the bottom surfaces thereof can be located in the same plane parallel to the XY plane. The height d₁ of the first prism 142a is smaller than the height d₂ of the second prism 142b (d₁<d₂) from the same plane. In this embodiment, the height d₁ of the first prism 142a is, for example, roughly 4.4 μm, and the height, d₂ of the second prism 142b is, for example, roughly 16.0 μm. In this embodiment, the width L₁ of the first prism 142a is larger than the width L₂ of the second prism 142b (L₁>L₂) in the same main surface. The ratio (L₁/L₂) of the width L₁ of the first prism 142a to the width L₂ of the second prism 142b is typically from. 1.5 to 4.5, both inclusive, and is preferably from 2.0 to 3.0, both inclusive.

In addition, the first and the second prisms 142a and 142b are arranged so that the hypothetical edge line at the vertex angle portion of the first prism 142a substantially overlaps the edge line at the vertex angle portion of the second prism 142b when looked down from the Z-direction. That is, the prism portion 142 has a shape obtained by covering the hypothetical edge line of the first prism 142a with the second prism 142b.

In this manner, the prism sheet 14 is configured so that the angle β of the vertex of the first prism 142a is larger than the angle θ of the vertex of the second prism 142b, and so that the height d₂ of the vertex of the second prism 142b is larger than the height d₁ of the first prism 142a.

The flat plate-like portion 141 and the prism portions 142, which are included in the prism sheet 14 described above, may be integrally made of a single transparent material, or may be made of mutually different transparent materials. Examples of the transparent material include, but are not limited to, a highly transparent polyester resin. The prism sheet 14 may be made of a laminated body with the flat plate-like portion 141 made of, for example, a polyester resin and with the prism portions 142 made of an acrylic rosin or a polycarbonate resin that has a higher refractive index than that of the flat plate-like portion 141.

### Example 1

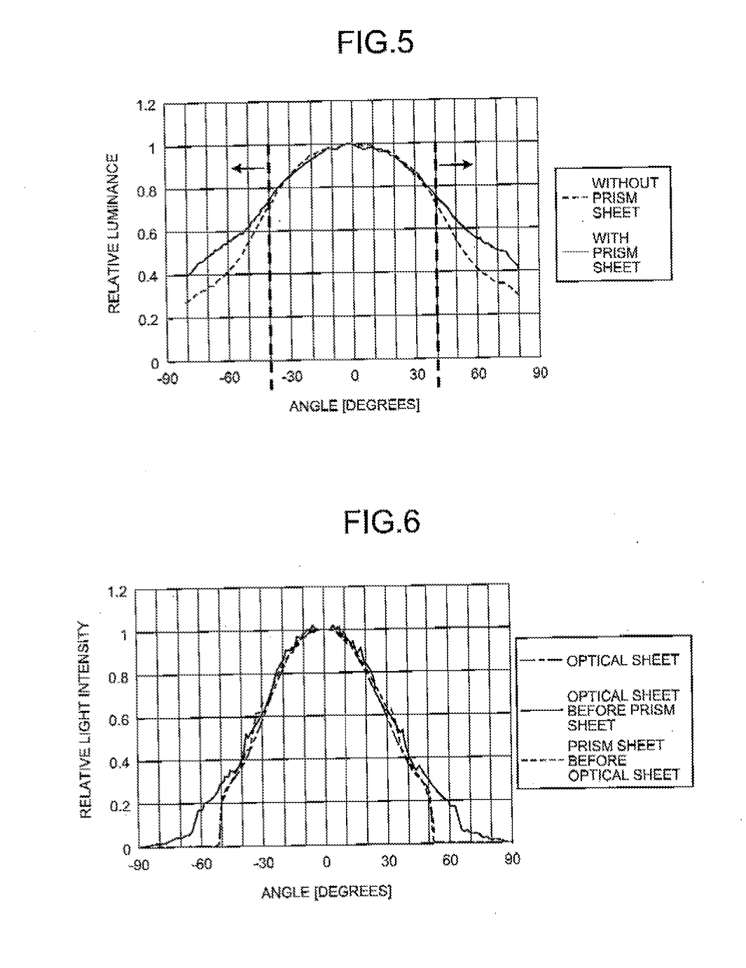

The inventors of the present invention conducted experiments on light distributions, using the planar illumination device 1 that includes the prism sheet 14 according to this embodiment configured as described above, and using a conventional planar illumination device having a configuration not including a prism sheet. The polarizing separation plate 15 is not provided. FIG. 5 illustrate the results. The vertical axis in the graph of FIG. 5 represents relative luminance expressed as ratios to the luminance at an angle of 0 degrees (in the normal direction of the screen) in the conventional planar illumination device.

It is found from FIG. 5 that the luminance greatly increases in ranges where the absolute value of the angle from the normal direction is 40 degrees or larger, particularly, 50 degrees or larger along the right-left direction (X-direction) of the planar illumination device 1. That is, it has been verified that the planar illumination device 1 has a larger illuminating angle of light than that conventionally obtained. Thus, a view angle can be increased on the display screen of an electronic device that uses the planar illumination device 1.

### Example 2

The inventors of the present invention conducted simulations on light distributions, using the planar illumination device 1 not provided with the polarizing separation plate 15 in the embodiment described above, a planar illumination device obtained by reversing the stacking order of the optical sheet 13 and the prism sheet 14 in this planar illumination device 1, and the conventional planar illumination device provided with neither the prism sheet 14 nor the polarizing separation plate 15. FIG. 6 illustrates the results. The vertical axis in the graph of FIG. 6 represents relative light intensities expressed as ratios to the light intensity at an angle of 0 degrees (in the normal direction of the screen) in the conventional planar illumination device.

It is found from FIG. 6 that the light intensity relatively increases in ranges where the angle from the normal direction is 50 degrees or larger along the right-left direction (X-direction) of the planar illumination device. That is, it has been verified that the view angle increases to 50 degrees or larger to the right and left with respect to the normal direction, that is, the full view angle increases to 100 degrees or larger, on the display screen of a display device including the planar illumination device 1. In contrast, it is found that only the same view angle as that of the conventional planar illumination device not provided with the prism sheet 14 can be obtained when the arranging order of the optical sheet 13 and the prism sheet 14 from the planar light source 11 is reversed in the planar illumination device 1 according to the embodiment described above. That is, it has been verified that the planar illumination device 1 can increase the illuminating angle of the light by including the optical sheet 13 made of a BEF or the like on the planar light source 11 side, and including the prism sheet 14 on the light emitting side of the optical sheet 13. Thus, the view angle can be increased on the display screen of the electronic device that includes the planar illumination device 1 according to the embodiment described above.

### Example 3

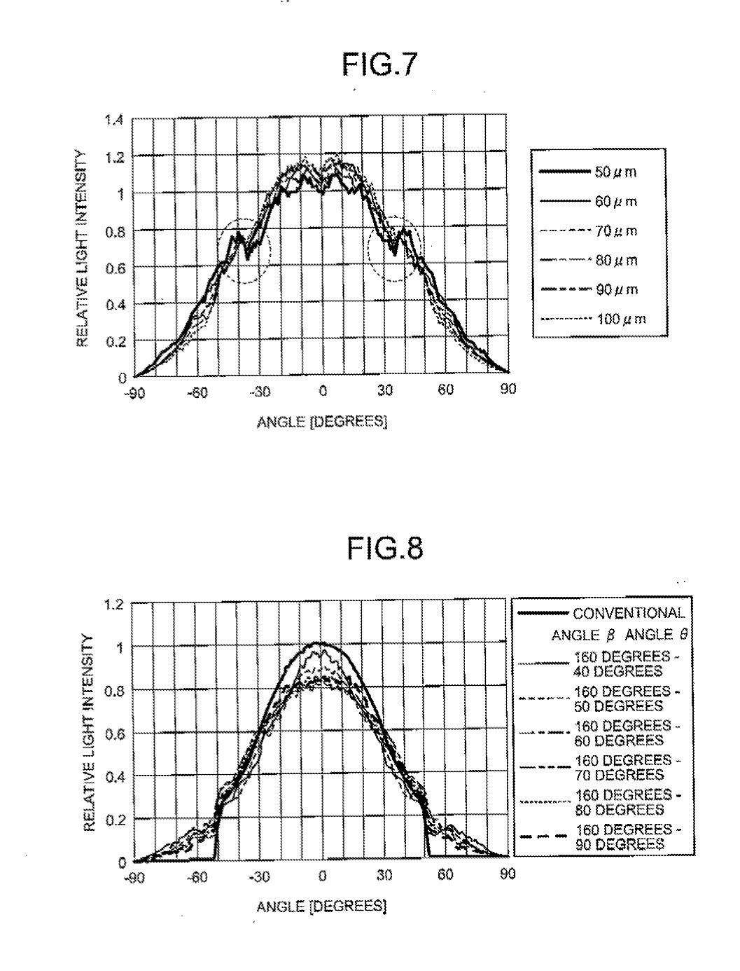

The inventors of the present invention conducted the simulations on light distributions, using the planar illumination device 1 in the cases where the arrangement pitch L₀ was set to various values in a range from 50 μm to 100 μm, both inclusive (50 μm≦L₀≦100 μm) while the shape of the prism portion 142 of the prism sheet 14 according to the embodiment described above was not changed. That is, the simulations on light distributions were conducted by setting the ratio of the width (L₀-L₁) of the flat surface portions 143 (refer to FIG. 3) to the prism width L₁ of the prism portion 142 to various values in a range from 0 to 1, both inclusive (0≦L₀/L₁-1≦1). FIG. 7 illustrates the results. The vertical axis in the graph of FIG. 7 represents relative light intensities expressed as ratios to the light intensity at an angle of 0 degrees (in the normal direction of the screen) in the planar illumination device 1 that includes the prism sheet 14 with the arrangement pitch L₀ set to 50 μm, that is, without the flat surface portions 143 on the deflection surface side.

It is found from FIG. 7 that the light intensity in the vicinity of the angle of 0 degrees (in the normal direction of the screen) in the planar illumination device 1 can be increased by increasing the arrangement pitch L₀ of the prism portions 142 to widen the area of the flat surface portions 143 between adjacent ones of the prism portions 142 so as to increase the ratio (1-L₀/L₁) of the flat surface portions 143 on the prism sheet 14. That is, it has been verified from FIG. 7 that increasing the ratio of the flat surface portions 143 can eliminate declines in light intensity in the vicinity of the normal direction in the planar illumination device 1.

In addition, it has been verified from FIG. 7 that increasing the ratio (1-L₀/L₁) of the flat surface portions 143 on the prism sheet 14 can eliminate declines in the vicinities of ranges where the absolute value of the angle along the right-left direction (X-direction) of the planar illumination device 1 is between 30 degrees and 40 degrees (in dashed-line circles in FIG. 7).

In view of the above, the ratio (L₀/L₁-1) of the width (L₀-L₁) of the flat surface portions 143 to the prism width L₁ of the prism portion 142 is set larger than 0 and equal to or smaller than 1 (0<L0/L1-1≦1). Thus, the light intensity can fee kept from partially declining along the right-left direction (X-direction) of the planar illumination device 1.

The inventors of the present invention conducted simulations on light distributions, using the prism sheet 14 in the planar illumination device 1 according to the embodiment described above in the cases where the angle β of the vertex of the first prism 142a was set to 160 degrees (Example 4), 140 degrees (Example 5), and 120 degrees (Example 6).

### Example 4

Specifically, in Examples 4, the simulations on the light distribution were conducted in the planar illumination device 1 that includes the prism sheet 14, in which the angle β of the vertex of the first prism 142a was fixed to 160 degrees, and the angle θ of the vertex of the second prism 142b was varied from 40 degrees to 90 degrees. FIG. 8 illustrates the results. For the purpose of comparison, FIG. 8 also illustrates the result of a simulation on a light distribution in the conventional planar illumination device not provided with the prism sheet 14 according to the embodiment described above. The vertical axis of the graph illustrated in FIG. 8 represents relative light intensities expressed as ratios to the light intensity at an angle of 0 degrees (in the normal direction of the screen) in the conventional planar illumination device.

It is found from FIG. 8 that the light intensity rapidly decreases when the absolute value of the angle along the right-left direction (X-direction) of the screen reaches 50 degrees or larger in the conventional planar illumination device. In contrast, it is found that the planar illumination device 1 according to this embodiment relatively increases the light intensity in ranges where the absolute value of the angle along the right-left direction (X-direction) of the screen is 50 degrees or larger in all cases where the vertex angle of the second prism 142b is set to an angle between 40 degrees and 90 degrees. That is, it has been verified that, in the prism sheet 14 used in the planar illumination device 1, the view angle is increased to 50 degrees or larger as the absolute value of the angle along the right-left direction by setting the angle β of the vertex of the first prism 142a to 160 degrees and the angle θ of the vertex of the second prism 142b to an angle between 40 degrees and 90 degrees. Thus, the view angle can be increased on the display screen of the electronic device that uses the planar illumination device 1 according to this embodiment.

### Example 5

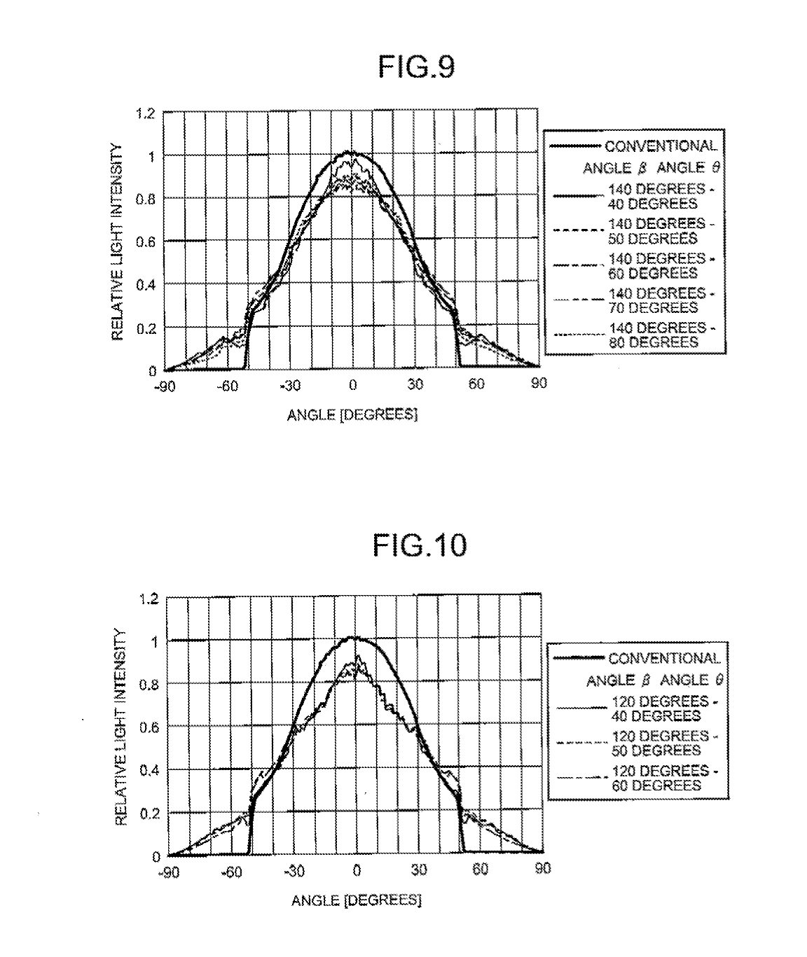

In Example 5, the simulations on the light distribution were conducted by fixing the angle β of the vertex of the first prism 142a to 140 degrees, varying the angle θ of the vertex of the second prism 142b to different values ranging from 40 degrees to 80 degrees, and keeping the other conditions to be the same as those of Example 4. FIG. 9 illustrates the results.

It has been verified from FIG. 9 that the planar illumination device 1 according to the embodiment relatively increases the light intensity in ranges where the absolute value of the angle along the right-left direction (X-direction) of the screen is 50 degrees or larger in all cases where the vertex angle of the second prism 142b is set to an angle between 40 degrees and 80 degrees. That is, it has been verified that the same effect as that of Example 4 can be obtained by setting the angle β of the vertex of the first prism 142a to 140 degrees and the angle θ of the vertex of the second prism 142b to an angle between 40 degrees and 80 degrees in the prism sheet 14.

### Example 6

In Example 6, the simulations on the light distribution were conducted by fixing the angle β of the vertex of the first prism 142a to 120 degrees, varying the angle θ of the vertex of the second prism 142b to different values ranging from 40 degrees to 60 degrees, and keeping the other conditions to be the same as those of Examples 4 and 5. FIG. 10 illustrates the results.

It has been verified from FIG. 10 that the planar illumination device 1 according to the embodiment relatively increases the light intensity in ranges where the absolute value of the angle along the right-left direction (X-direction) of the screen is 50 degrees or larger in all cases where the vertex angle of the second prism 142b is set to an angle between 40 degrees and 60 degrees. That is, it has been verified that the same effect as that of Examples 4 and 5 can be obtained by setting the angle β of the vertex of the first prism 142a to 120 degrees and the angle β of the vertex of the second prism 142b to an angle between 40 degrees and 60 degrees in the prism sheet 14.

### Example 7

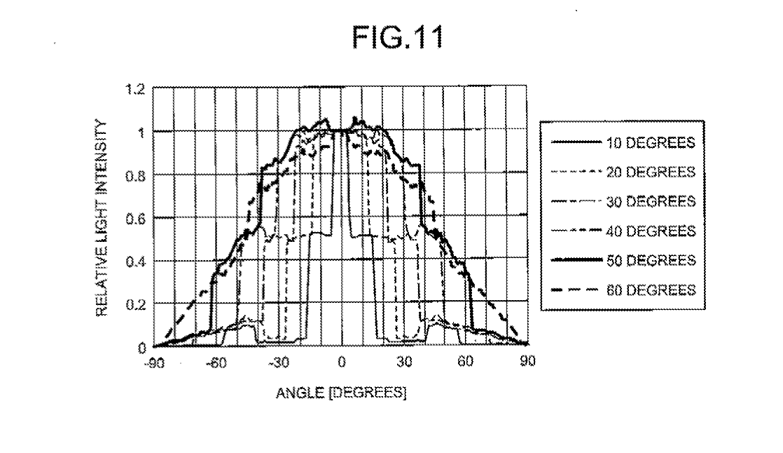

The inventors of the present invention further studied a case of using the prism sheet 14 stand-alone. That is, the incidence angle of light incident on the prism sheet 14 with respect to the normal direction was varied to different values in the range from 10 degrees to 60 degrees, and the relative light intensity of the light transmitted through the prism sheet 14 according to the embodiment described above was measured. FIG. 11 illustrates the results. The relative light intensities represented on the vertical axis in FIG. 11 are expressed as ratios to the light intensity when the angle is 0 degrees.

It is found from FIG. 11 that the light is widely distributed after passing through the prism sheet 14 in all the cases. It is also found that, when the incidence angle of the incident light is small, the entire range is clearly divided into a range where the light distribution depends on the incidence angle and a range where the light distribution depends on the refractive index of the prisms included in the prism sheet 14. It is further found that the boundary between the range of dependence on the incidence angle and the range of dependence on the refractive index of the prisms becomes more unclear as the incidence angle increases. When the incidence angle reaches 60 degrees (thick dashed line in FIG. 11), the range of dependence on the incidence angle and the range of dependence on the refractive index of the prisms become inseparable. That is, the orientation distribution (orientation angle) of the light with respect to the prism sheet 14 is found to be preferably roughly 60 degrees or larger. It has also been verified that the first and the second prisms 142a and 142b need to be adjusted according to the incidence angle of the incident light.

While the above has described the embodiment of the present invention, the present invention is not limited to the embodiment described above, and can be variously modified based on the technical idea of the present invention. For example, the materials and the numerical values mentioned in the embodiment described above are merely examples. Materials and numerical values different therefrom may be used as needed.

In the embodiment of the present invention, the vertex of each of the first and the second prisms 142a and 142b has a pointed shape for the sake of description of the shape. However, the shape of the vertex is not limited to the pointed shape, and may be smooth and substantially circular arc-shaped. In the same manner, the boundary portion between the first and the second prisms 142a and 142b may also be smooth and substantially circular arc-shaped. That is, applicable shapes of the formed portion of the prism sheet 14 described above naturally include a smooth shape without corners.

The prism sheet and the planar illumination device according to the present invention enable an electronic device including a display screen to have a larger view angle and thereby make a viewable range of an image wider.

Although the invention has been described, with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A prism sheet comprising;
a transparent plate portion having a flat plate-like shape, and configured to transmit at least part of visible light; and
a plurality of prism portions provided on a main surface of the transparent plate portion, and configured to deflect at least part of the visible light, wherein
each of the plurality of prism portions has a shape obtained by combining at least a first prism and a second prism,
the first prism has a first triangular prismatic shape having a sectional shape of an obtuse triangle when cut orthogonally to a longitudinal direction of the first prism, and a side surface side of the first prism corresponding to a base of the obtuse triangle in the first triangular prismatic shape is disposed on the transparent plate portion side of the first prism,
the second prism has a second triangular prismatic shape having a sectional shape of a triangle having a vertex angle of 90 degrees or smaller when cut orthogonally to a longitudinal direction of the second prism, and a side surface side of the second prism corresponding to a base of the triangle in the second triangular prismatic shape is disposed on the transparent plate portion side of the second prism,
each of the plurality of prism portion has a shape in which a prism width of the base of the obtuse triangle in the first prism is larger than a prism width of the base of the triangle in the second prism, in which a height of the obtuse triangle in the first prism is smaller than a height of the triangle in the second prism, and in which an edge line of the first prism substantially overlaps an edge line of the second prism when looked down from a normal direction of the main surface, and
edge lines of the second prisms are substantially parallel to one another in the plurality of prism portions.

2. The prism sheet according to claim 1, wherein a flat surface portion is provided between two adjacent ones of the prism portions of the plurality of prism portions, on the main surface of the transparent plate portion.

3. The prism sheet according to claim 2, wherein a ratio of a width of the flat surface portion to the prism width of the first prism is larger than 0 and equal to or smaller than 1.

4. The prism sheet according to claim 1, wherein a vertex angle of the obtuse triangle in the first prism is from 120 degrees to 160 degrees, both inclusive.

5. The prism sheet according to claim 1, wherein the vertex angle of the triangle in the second prism is from 40 degrees to 90 degrees, both inclusive.

6. The prism sheet according to claim 1, wherein the triangle in the first prism is a substantially isosceles triangle, and the triangle in the second prism is an isosceles triangle.

7. A planar illumination device comprising:
a planar light source configured to emit light in a planar form;
an optical sheet provided on a light emitting side of the planar light source, and having a flat surface on a light incidence side thereof and a light deflection surface on a light emitting side thereof; and
the prism sheet according to claim 1, the prism sheet being provided on the light emitting side of the optical sheet in an arrangement in which the main surface is located on a light incidence side of the prism sheet.
